(19) United States
(12) Patent Application Publication
(10) Pub. No.: US 2011/0243426 A1
(43) Pub. Date: Oct. 6, 2011

(54) METHOD, APPARATUS, AND PROGRAM FOR GENERATING CLASSIFIERS

(76) Inventor: Yi HU, Kanagawa-ken (JP)

(21) Appl. No.: 13/032,313

(22) Filed: Feb. 22, 2011

(30) Foreign Application Priority Data
Apr. 3, 2010 (JP) 047239/2010

(51) Int. Cl. G06K 9/62

(52) U.S. Cl. 382/159

(57) ABSTRACT

Classifiers, which are combinations of a plurality of weak classifiers, for discriminating objects included in detection target images by employing features extracted from the detection target images to perform multi class discrimination including a plurality of classes regarding the objects are generated. When the classifiers are generated, learning is performed for the weak classifiers of the plurality of classes, sharing only the features.

### BACKGROUND OF THE INVENTION

1. Field of the Invention

The present invention is related to a classifier generating apparatus and a classifier generating method, for generating classifiers having tree structures for performing multi class classification of objects. The present invention is also related to a program that causes a computer to execute the classifier generating method.

2. Description of the Related Art

Conventionally, correction of skin tones in snapshots photographed with digital cameras by investigating color distributions within facial regions of people, and recognition of people who are pictured in digital images obtained by digital video cameras of security systems, are performed. In these cases, it is necessary to detect regions (facial regions) within digital images that correspond to people's faces. For this reason, various techniques for detecting faces from within digital images have been proposed. Among these techniques, there is a known detecting method that employs appearance models constructed by a machine learning technique. The detecting method that employs appearance models employs a plurality of linked weak classifiers which are obtained by learning a great number of sample images by machine learning. Therefore, this method is robust and superior in detection accuracy.

The detecting method that employs appearance models will be described as a technique for detecting images within digital images. In this method, features of faces are learned by employing a face sample image group consisting of a plurality of sample images of different faces, and a non face sample image group consisting of a plurality of sample images which are known not to be of faces, as learning data to generate classifiers capable of judging whether an image is an image of a face. Then, partial images are sequentially cut out from an image in which faces are to be detected (hereinafter, referred to as “detection target image”), and the aforementioned classifiers are employed to judge whether the partial images are of faces. Finally, the regions of the detection target image corresponding to the partial images which are judged to be faces are extracted, to detect faces within the detection target image.

Not only forward facing faces, but images in which faces are rotated along the plane of the image (hereinafter, referred to as “in plane rotation”) and images in which faces are rotated within the plane of the image (hereinafter, referred to as “out of plane rotation”) are input to the classifiers. In the case that learning is performed using learning data that include faces of a variety of orientations (faces in multiple views), it is difficult to realize a general use classifier capable of detecting faces in all orientations. For example, the rotational range of faces that a single classifier is capable of classifying is limited to approximately 30 degrees for in plane rotated images, and approximately 30 to 60 degrees for out of plane rotated images. For this reason, classifiers for faces are constituted by a plurality of strong classifiers for respectively discriminating faces in each of a plurality of orientations, in order to efficiently extract statistical features of faces, which are detection targets. Specifically, multi class classifying methods have been proposed, in which a plurality of strong classifiers, which have performed multi class learning to enable classification of images in each orientation, are prepared. Next, all of the strong classifiers are caused to perform classification regarding whether images are faces in specific orientations. Then, it is judged whether the images represent faces, from the ultimate outputs of each of the strong classifiers.

Here, it is necessary to select features which are optimal for multi class learning from among a plurality of filters for obtaining features, to perform efficient learning of a plurality of weak classifiers that constitutes strong classifiers of each class during multi class learning. For this reason, a technique for selecting optimal features for multi class learning by searching for effective features and sharing relationships of features among classes has been proposed (refer to Japanese Unexamined Patent Publication No. 2006-251955). In addition, a technique in which a predetermined number of weak classifiers are linked such that weak classifiers of a previous step are shared, from among a plurality of weak classifiers that constitute a classifier of each class, and the weak classifiers are branched according to the number of classes, has also been proposed (refer to U.S. Patent Application Publication No. 20090116693).

Further, the Joint Boost algorithm has also been proposed as a technique for performing multi class learning. The Joint Boost learning algorithm reduces the total number of weak classifiers and improves the classification performance of classifiers, by causing weak classifiers to be shared among classes (refer to A. Torralba et al., “Sharing features: efficient boosting procedures for multiclass object detection”, Proceedings of the IEEE Computer Society Conference on Computer Vision and Pattern Recognition (CVPR), Vol. 2, pp. 762-769, 2004). In addition, a technique in which positive teacher data are classified when performing learning of weak classifiers in the Joint Boost algorithm, by labeling positive teacher data that belong to a learning target class as 1, and labeling positive teacher data that belong to other classes as 0 or −1 (refer to M. Tsuchiya and H. Fujiyoshi, “A Method for Constructing a High-Accuracy Classifier Using Divide and Conquer Strategy Based on Boosting”, Technical Report of IEICE, Information and Communication Engineers, Vol. 109, No. 182, PRMU2009-66, pp. 81-86, 2009).

Weak classifiers obtain features from input patterns, and employ the features as materials for judgment for classifying mechanisms included in the weak classifiers to judge whether the input patterns have certain attributes. In the Joint Boost technique, learning is performed by labeling positive learning data for a learning target class as 1 and labeling positive learning data for other classes as −1, and features are selected such that classification lass error obtained by learning becomes minimal.

However, in the aforementioned Joint Boost technique, not only the features but the weak classifiers are shared among classes. Therefore, an inconsistency that pieces of positive learning data having labels of different values are input to the same weak classifier, exists. Because such an inconsistency is present in the Joint Boost technique, it becomes difficult for learning to converge such that the classification loss error becomes minimal. In addition, the effects of learning are weakened by the presence of this inconsistency, and the performance of strong classifiers constituted by such weak classifiers is limited to the performance of several weak classifiers in the first step. In addition, because the weak classifiers are shared, performing accurate classification regarding objects among classes becomes difficult. Further, in the case that a complex classification structure, such as a tree structure, is constructed, classes cannot be distinguished because the weak classifiers are shared. As a result, designing branches of such tree structures is difficult.

### SUMMARY OF THE INVENTION

The present invention has been developed in view of the foregoing circumstances. It is an object of the present invention to solve the deficiencies of the Joint Boost technique when generating classifiers for performing multi class classification, to improve the converging properties of learning and the performance of classifiers.

A classifier generating apparatus of the present invention generates classifiers, which are combinations of a plurality of weak classifiers, for discriminating objects included in detection target images by employing features extracted from the detection target images to perform multi class discrimination including a plurality of classes regarding the objects, and is characterized by comprising:

learning means, for generating the classifiers by performing learning of the weak classifiers of the plurality of classes, sharing only the features.

The “weak classifiers” are classifiers that judge whether features obtained from images represent objects, in order to classify the objects. In the Joint Boost technique described above, not only features, but weak classifiers, more specifically classifying mechanism-s included in the weak classifiers, are shared among classes during learning. The “learning . . . sharing only the features” performed by the classifier generating apparatus of the present invention differs from the Joint Boost technique in that only the features are shared, and the classifying mechanisms within the weak classifiers are not shared.

The classifier generating apparatus may further comprise:

learning data input means, for inputting a plurality of positive and negative learning data for the weak classifiers to perform learning for each of the plurality of classes; and

filter storage means, for storing a plurality of filters that extract the features from the learning data. In this case, the learning means extracts the features from the learning data using filters selected from those stored in the filter storage means, and performs learning using the extracted features.

The “filters that extract the features” are those that define the positions of pixels which are employed to calculate features within images, the method for calculating features using the pixel values of pixels at these positions, and the sharing relationship of features among classes. In addition, the features are shared among classes in the present invention. Therefore, the filters for extracting features also define sharing data regarding among which classes features are shared.

In the classifier generating apparatus of the present invention, the learning means may perform labeling with respect to all of the learning data to be utilized for learning according to degrees of similarity to positive learning data of classes to be learned, to stabilize learning.

In the classifier generating apparatus of the present invention, the learning means may perform learning by:

defining a total sum of weighted square errors of the outputs of weak classifiers at the same level in the plurality of classes with respect to the labels and input features;

defining the total sum of the total sums for the plurality of classes as classification loss error; and

determining weak classifiers such that the classification loss error becomes minimal.

A classifier generating method of the present invention generates, which are combinations of a plurality of weak classifiers, for discriminating objects included in detection target images by employing features extracted from the detection target images to perform multi class discrimination including a plurality of classes regarding the objects, and is characterized by comprising:

a learning step, for generating the classifiers by performing learning of the weak classifiers of the plurality of classes, sharing only the features.

A program of the present invention is characterized by causing a computer to execute the functions of the classifier generating apparatus of the present invention.

The present invention generates classifiers, by performing learning such that only features are shared by weak classifiers of a plurality of classes, without sharing the weak classifiers. For this reason, learning not converging as in the Joint Boost technique will not occur. As a result, the converging properties of learning can be improved compared to the Joint Boost technique. In addition, because weak classifiers are not shared, classification among classes can be accurately performed.

Further, because the weak classifiers of classes that share features are different from each other, designing branches of tree structures is facilitated, when classification structures, such as tree structures, are constructed. For this reason, the classifier generating apparatus and the classifier generating method of the present invention are suited for designing classifiers having tree structures.

### BRIEF DESCRIPTION OF THE DRAWINGS

FIG. 1 is a block diagram that illustrates the schematic structure of a classifier generating apparatus according to an embodiment of the present invention.

FIG. 2 is a diagram that illustrates learning data for m+1 classes (C1 through Cm and a background class).

FIGS. 3A and 3B are diagrams that illustrate examples of learning data.

FIG. 4 is a diagram that illustrates an example of a filter.

FIG. 5 is a conceptual diagram that illustrates the processes performed by the classifier generating apparatus according to the embodiment of the present invention.

FIG. 6 is a diagram that illustrates the results of labeling of learning data in the case that there are eight classes (C1 through C7 and a background class).

FIG. 7 is a diagram that schematically illustrates a multi class classifier constructed by the embodiment of the present invention.

FIG. 8 is a flow chart that illustrates a learning process.

FIG. 9 is a diagram that illustrates an example of a histogram.

FIG. 10 is a diagram that illustrates quantization of a histogram.

FIG. 11 is a diagram that illustrates an example of a generated histogram.

FIG. 12 is a diagram that illustrates the construction of a classifier generated by the embodiment of the present invention.

FIG. 13 is a diagram that illustrates sharing of weak classifiers in the Joint Boost technique.

FIG. 14 is a diagram that illustrates the construction of a classifier generated by the Joint Boost technique.

FIG. 15A is a first diagram that illustrates a classifier constructed by the Joint Boost technique and a classifier constructed by the embodiment of the present invention in a comparative manner.

FIG. 15B is a second diagram that illustrates a classifier constructed by the Joint Boost technique and a classifier constructed by the embodiment of the present invention in a comparative manner.

FIG. 16 is a diagram that illustrates the relationship between input to a decision tree and output thereof.

### DESCRIPTION OF THE PREFERRED EMBODIMENTS

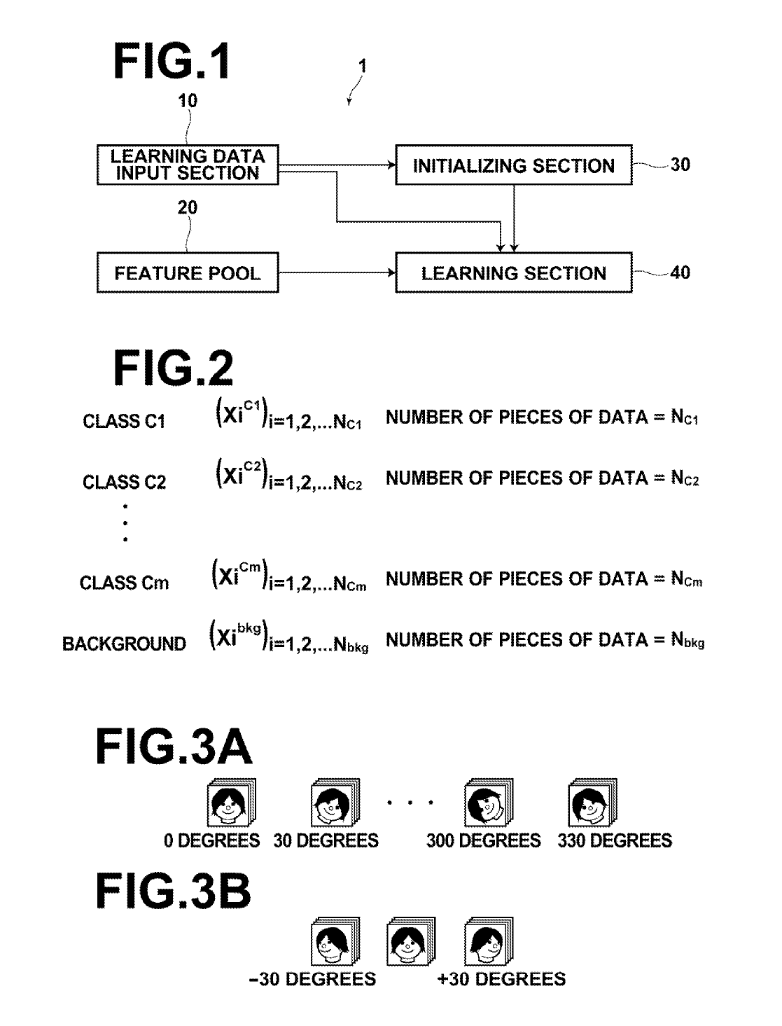

Hereinafter, embodiments of the present invention will be described with reference to the attached drawings. FIG. 1 is a block diagram that illustrates the schematic structure of a classifier generating apparatus 1 according to an embodiment of the present invention. As illustrated in FIG. 1, the classifier generating apparatus 1 of the present invention is equipped with: a learning data input section 10; a feature pool 20; an initializing section 30; and a learning section 40.

The learning data input section 10 inputs learning data to be utilized for classifier learning into the classifier generating apparatus 1. Here, the classifiers which are generated by the present embodiment are those that perform multi class classification. For example, in the case that the classification target object is a face, the classifiers are those that perform multi class classification to classify faces which have different orientations along the plane of the image and different facing directions within the images. Accordingly, the classifier generating apparatus 1 of the present invention generates m classes of classifiers, each capable of classifying faces of a different orientation. For this reason, the learning data input section 10 inputs different learning data xᵢ^{Cu} (i=1−N_{Cu}, u=1−m, and N_{Cu} is the number of pieces of learning data corresponding to each class Cu), that is, learning data in which the orientations and facing directions of faces are different, into the classifier generating apparatus 1. Note that in the present embodiment, the learning data are image data, in which the sizes and the positions of feature points (such as eyes, noses, etc.) are normalized.

In addition, learning data xᵢ^{bkg} (number of data N_{bkg}) that represent backgrounds that do not belong to any class of the classification target object are also input into the classifier generating apparatus 1 of the present embodiment. Accordingly, learning data for m+1 classes as illustrated in FIG. 2 are input and utilized to generate classifiers.

FIGS. 3A and 3B are diagram that illustrate examples of learning data. Note that FIGS. 3A and 3B illustrate learning data to be utilized for classifiers that classify faces. As illustrated in FIGS. 3A and 3B, the learning data are of a predetermined image size, and include twelve types of in plane rotated images (FIG. 3A), in which faces positioned at a set position (the center, for example) within the images are rotated in 30 degree increments, and three types of out of plane rotated images (FIG. 3B), in which faces are positioned at a set position within the images are facing directions of 0 degrees, −30 degrees, and +30 degrees. By preparing learning data in this manner, 12·3=36 class classifiers are generated. Note that the classifiers of each class are constituted by a plurality of linked weak classifiers.

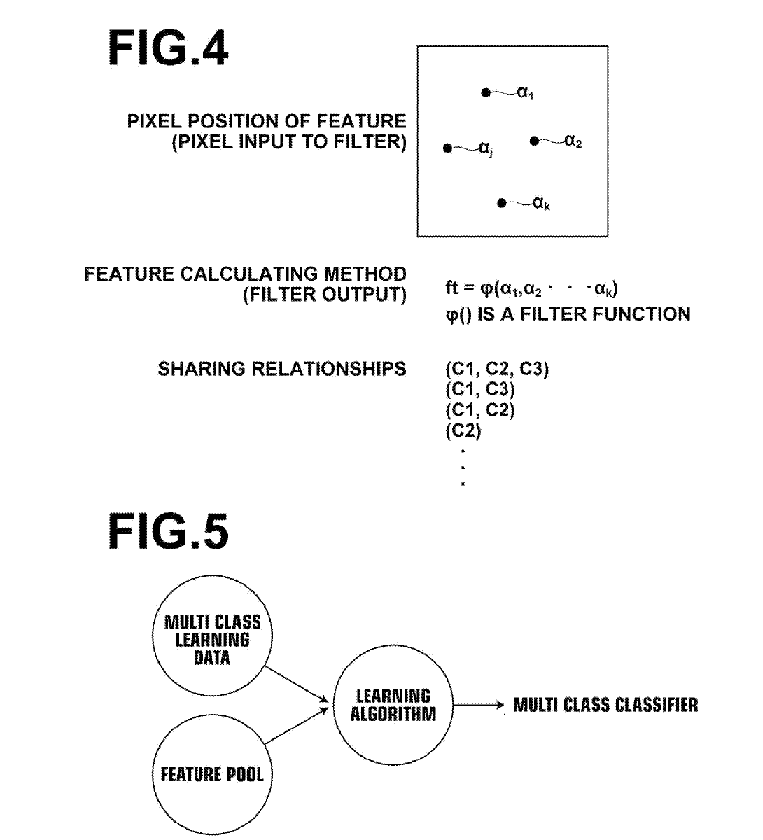

A plurality of filters ft, for extracting features to be employed to judge whether classification target image data belong in a certain class from the learning data, are stored in the feature pool 20. The filters ft define the positions of pixels which are employed to calculate features within the learning data, the method for calculating features using the pixel values of pixels at these positions, and the sharing relationship of features among classes. FIG. 4 is a diagram that illustrates an example of a filter. The filter ft illustrated in FIG. 4 obtains pixel values (α1 through αk) of k points or k blocks which are determined advance within classification target image data, and defines that calculations are to be performed using a filter function φ among the pixel values obtained for α1 through αk. Note that the pixel values α1 through αk are input to the filter ft, and the calculation results of the filter function φ are output by the filter ft.

The features are shared among classes in the present embodiment. Therefore, in the case that there are three classes C1 through C3, there will be seven types of sharing relationships, (C1, C2, C3), (C1, C2), (C1, C3), (C2, C3), (C1), (C2), and (C3). The filters define one of these sharing relationships. Note that the learning data and the filters ft within the feature pool 20 are defined and prepared in advance by users.

FIG. 5 is a conceptual diagram that illustrates the processes performed by the classifier generating apparatus 1 according to the embodiment of the present invention. Hereinafter, each of the processes performed by the initialing section 30 will be described. First, labeling of learning data will be described. Labeling of learning data is performed to indicate whether pieces of learning data belong to a learning target class during learning of weak classifiers for each class. As shown below, labels for all classes are set for each piece of learning data xᵢ^{C}. Note that setting labels for all classes clarifies whether each piece of learning data xᵢ^{C} (belonging to class C) is to be treated as positive teacher data or negative teacher data during learning of each class Cu. Whether each piece of learning data is to be treated as positive teacher data or negative teacher data is determined by the labels.

xᵢ^{C}→(zᵢ^{C1}, zᵢ^{C2}, . . . , zᵢ^{Cm})

Here, assuming that C∈ [C1, C2, . . . , Cm, bkg], in the case that C=Cu (u=1 through m, that is, learning data are not background images), the labeling section 30A of the initializing section 30 sets the value of the label to +1 (zᵢ^{Cu}=+1). Conversely, in the case that C=bkg (that is, learning data are background images), the value of the label is set to −1 (zᵢ^{Cbkg}=−1). In addition, in the case that the learning data are not background images, the values of labels are set further, as described below. In cases that the class of the weak classifier which is a learning target and the class of a piece of learning data does not match, for example, a case in which the class of the learning target weak classifier is C1, and the class of a piece of learning data to be utilized for the learning is C3 (a piece of learning data xᵢ^{C3}, for example), the value of the label is set according to the degree of similarity within the class of the learning data for the learning target weak classifier and the learning data of different classes. For example, in cases that the class of the learning target weak classifier and the classes of the learning data are similar, such as a case in which the class of the learning target weak classifier is C3 and the classes of the learning data are C2 or C4, the values of labels are set to 0 (zᵢ^{Cu}=0) Conversely, in cases that the class of the learning target weak classifier and the classes of the learning data are not similar, such as a case in which the class of the learning target weak classifier is C3 and the classes of the learning data are C1 or C6, the values of labels are set to −1 (zᵢ^{Cu}=−1). Note that pieces of learning data having labels valued +1 are positive teacher data, and pieces of learning data having labels valued −1 are negative teacher data.

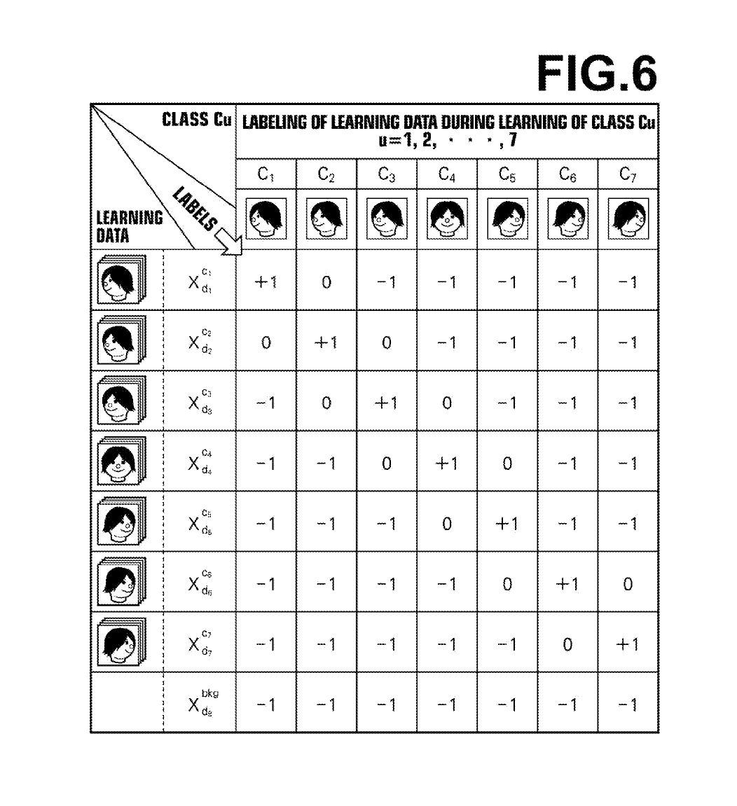

Note that judgments regarding whether learning data of a class for a learning target weak classifier and learning data of another class are similar are performed in the following manner. If a class is adjacent to another class, the learning data of the two classes are judged to be similar, and learning data of other classes are judged to not be similar. Accordingly, in the case that the class of a learning target weak classifier is C3, the values of labels zᵢ^{C3} for learning data of class C3 are set to +1, the values of labels zᵢ^{C2} and zᵢ^{C4} for learning data of adjacent classes C2 and C4 are set to 0, and the values of labels for learning data of all other classes are set to −1. Accordingly, in the present embodiment, the values of the labels zᵢ^{Cu} assume the three values of −1, 0, and +1. By setting the labels as described above, the stability of learning of the weak classifiers of the classes Cu using the learning data xᵢ^{C} can be improved. It is necessary to perform learning for seven classes, each of which are assigned faces having different facing directions in 20 degree increments, from a leftward facing face in profile to a rightward facing face in profile, in order to detect faces and to classify the facing directions thereof. The results of labeling for learning data for such a case are illustrated in FIG. 6.

Note that judgments regarding whether learning data are similar to each other may alternatively be performed by calculating correlations among the learning data of the classes, and judging that the learning data are similar if the correlation is a predetermined value or higher. As a further alternative, users may judge whether learning data of different classes are similar, by manual operations.

Next, the normalizing process for the number of pieces of learning data performed by the normalizing section 30 will be described. As described above, learning data are prepared for each class. However, there are cases in which the numbers of pieces of learning data differ among classes. In addition, in the classifier generating apparatus 1 of the present embodiment, learning data of classes having labels zᵢ^{Cu} valued +1 and −1 with respect to the classes of learning target weak classifiers are employed for learning, and learning data of classes having labels zᵢ^{Cu} valued 0 are weighted as 0 and are not utilized, as will be described later. Here, learning data having labels zᵢ^{Cu} valued +1 with respect to a certain class Cu are employed as positive learning data, and learning data having labels zᵢ^{Cu} valued −1 are employed as negative learning data. If the number of pieces of positive learning data is designated as N+^{Cu} and the number of pieces of negative learning data is designated as N−^{Cu} for a certain class Cu, the number of pieces of learning data N_{tchr}^{Cu} for the class Cu can be expressed as N+^{Cu}+N−^{Cu}.

In the present embodiment, the numbers of pieces of learning data N_{tchr}^{Cu} for all classes Cu are normalized such that the number of pieces of learning data N_{tchr}^{Cu} for each class is equal to a number ₘᵢₙN_{tchr}^{Cu} of pieces of learning data of a class Cu having the smallest number of pieces of learning data. Note that it is necessary to reduce the number of pieces of learning data for classes other than the class having the smallest number of pieces of learning data ₘᵢₙN_{tchr}^{Cu}. At this time, randomly selected pieces of learning data from among background learning data xᵢ^{bkg} may be removed from the negative learning data, to reduce the number of pieces of learning data. The number of pieces of learning data N_{tchr}^{Cu} for each class Cu is updated to become the normalized number of pieces of learning data, and the normalizing process with respect to the learning data is completed.

Next, the weight setting process administered on the learning data by the weight setting section 30C will be described. Weighting refers to weighting of the learning data during learning of the weak classifiers of each class Cu. As shown below, weighting values for m classes are set for each piece of learning data xᵢ^{C}.

xᵢ^{C}→wᵢ(wᵢ^{C1}, wᵢ^{C2}, . . . , wᵢ^{Cm})

Here, assuming that C∈ [C1, C2, . . . , Cm, bkg], weighting values wᵢ^{Cu} are set with respect to pieces of learning data xᵢ^{Cu} within a class Cu, based on the values of the labels zᵢ^{Cu} thereof. Specifically, weighting wᵢ^{Cu} is set as 1/(2N+^{Cu}) for positive learning data having labels zᵢ^{Cu} with values of +1 for a certain class Cu, set as 1/(2N−^{Cu}) for negative learning data having labels zᵢ^{Cu} with values of −1 for the class Cu, and set as 0 for positive learning data having labels zᵢ^{Cu} with values of 0 for the class Cu. Accordingly, the learning data having labels valued 0 are not utilized for learning of the class Cu. Note that N+^{Cu} is the number of pieces of positive learning data within a class Cu, and N−^{Cu} is the number of negative pieces of negative learning data within a class Cu.

Note that the classifier initializing section 30D initializes the classifiers of the classes Cu such that the number of weak classifiers is 0 for each class. That is, the classifiers are initialized such that no weak classifiers are present.

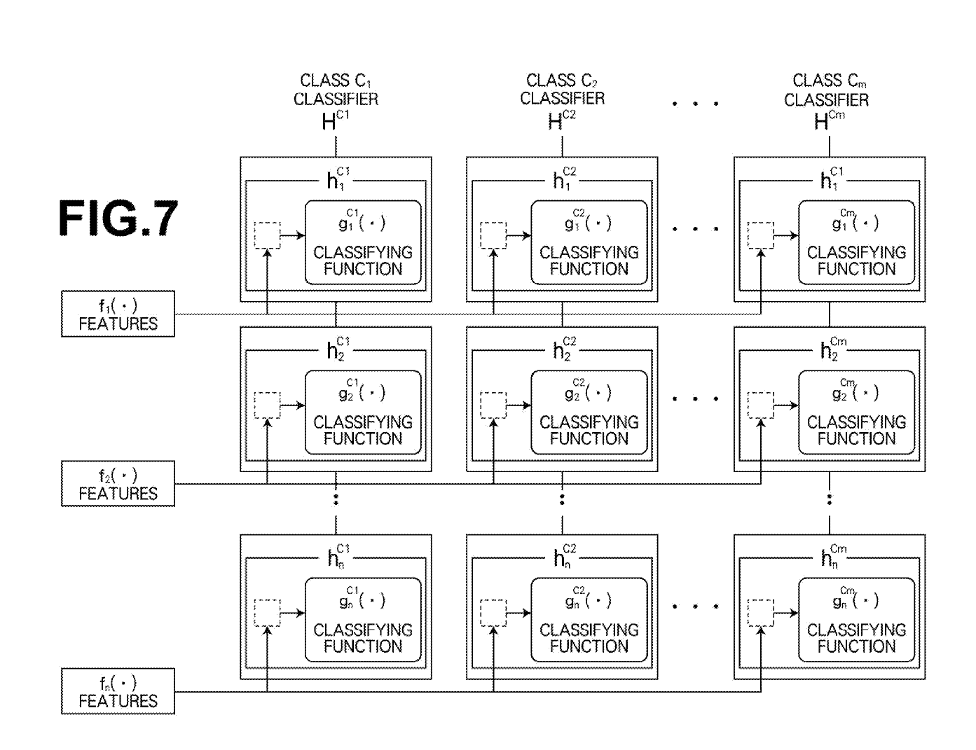

Next, the learning processes performed by the learning section 40 will be described. The multi class classifiers which are generated by the present embodiment are constituted by strong classifiers H^{Cu} for each class Cu (that is, H^{C1}, H^{C2}, . . . , H^{Cm}). The strong classifier of each class H^{Cu} is constituted by a plurality of weak classifiers hₜ^{Cu} (t=1˜n, n is the number of weak classifier steps) which are linked. FIG. 7 is a diagram that schematically illustrates a multi class classifier constructed by the embodiment of the present invention. In FIG. 7, the strong classifiers are connected by the sharing relationships with respect to the features.

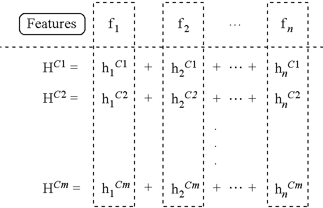

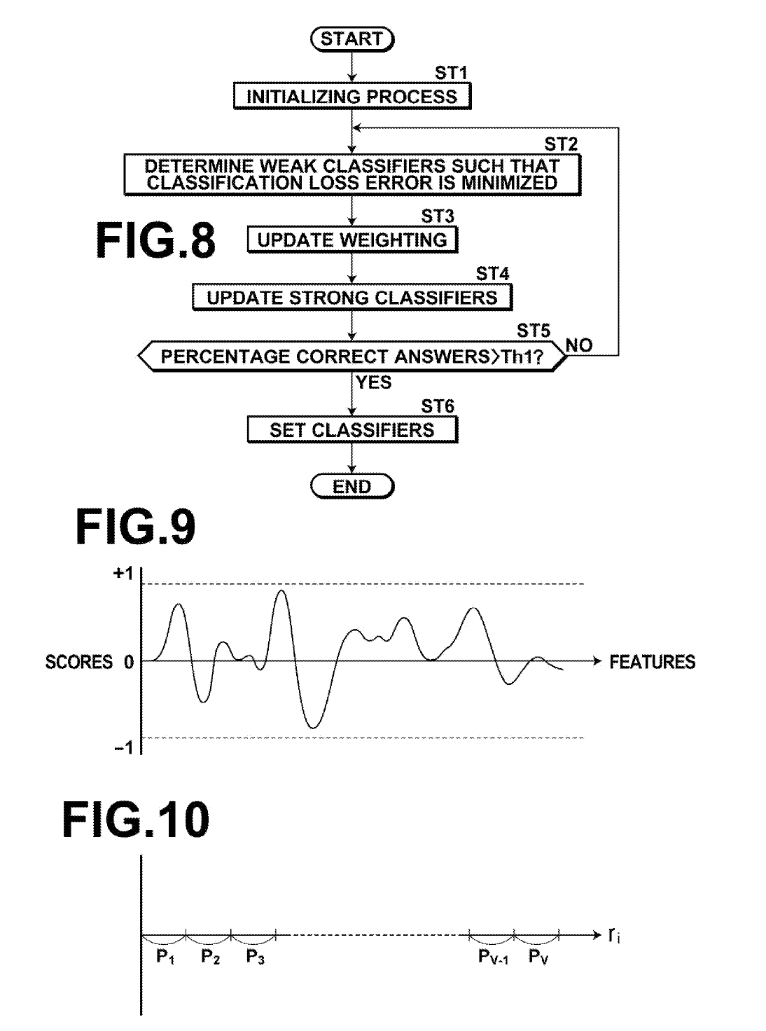

FIG. 8 is a flow chart that illustrates the steps of a learning process. Note that the labeling of learning data, the normalization of the numbers of pieces of learning data, setting the weighting of the learning data, and initialization of the classifiers (initialization processes) of step ST1 are performed by the initializing section 30. The learning performed by the learning section 40 proceeds by sequentially determining the weak classifiers hₜ^{Cu} for each step of the classifiers H^{Cu} for each class. First, the learning section 40 selects a filter ft arbitrarily from among the feature pool 20. Then, the sharing relationship defined by the selected filter ft is referred to, to determine the classes that features are to be shared among. Here, if classifying mechanisms for calculating scores for classification from the features ft(xᵢ) within the weak classifiers hₜ^{Cu} are designated as gₜ^{Cu}, the process that the weak classifiers hₜ^{Cu} perform using the features can be represented as hₜ^{Cu}(xᵢ)=gₜ^{Cu}(ft(xᵢ)). Note that hₜ^{Cu}(xᵢ) represents scores which are output by weak classifiers hₜ^{Cu} regarding learning data, of which the features are extracted by the selected filter ft.

In the present embodiment, histogram type classifying functions are utilized as classifying mechanisms. Weak classifiers are determined by generating histograms that determine scores with respect to the values of features obtained from the learning data. In the classifying mechanisms of histogram type classifying functions, the probability that an object is the object of a classification target class increases as the score is greater in the positive direction, and probability that an object is not the object of a classification target class increases as the score is greater in the negative direction.

Here, the purpose of learning is to determine weak classifiers. For this reason, the learning section 40 employs the labels zᵢ^{Cu} and weights wᵢ^{Cu} of the learning data xᵢ of each class and defines weighted square errors of the labels zᵢ^{Cu} and the scores as loss error, to determine the weak classifiers. The learning section defines a total sum of loss errors for all pieces of learning data xᵢ in this manner. For example, the amount of loss error J^{C1} for class C1 may be defined by Formula (1) below. Note that in Formula (1), Ntchr is the total number of pieces of learning data.

$$\begin{matrix}{J}^{C 1} = {{w}_{1}^{C 1} ( {z}_{1}^{C 1} - {h}_{t}^{C 1} ( {x}_{1} ) )}^{2} + {{w}_{2}^{C 1} ( {z}_{2}^{C 1} - {h}_{t}^{C 1} ( {x}_{2} ) )}^{2} + \\ {{w}_{3}^{C 1} ( {z}_{3}^{C 1} - {h}_{t}^{C 1} ( {x}_{3} ) )}^{2} + ⋯ + {w}_{Ntchr} ( {z}_{Ntchr} - {h}_{t}^{C 1} ( {x}_{Ntchr} ) ) \\ = {\sum }_{i = 1}^{{N}_{tchr}} {{w}_{i}^{C 1} ( {z}_{i}^{C 1} - {h}_{t}^{C 1} ( {x}_{i} ) )}^{2}\end{matrix} \qquad ( 1 )$$

Then, the learning section 40 defines the total sum of loss errors J^{Cu} for all classes within each branch (or the root) as classification loss error J_{wse} according to Formula (2) below.

$$\begin{matrix}{J}_{wse} = {\sum }_{i = 1}^{Ntchr} {{w}_{i}^{C 1} ( {z}_{i} - {h}_{t}^{C 1} ( {x}_{i} ) )}^{2} + {\sum }_{i = 1}^{Ntchr} {{w}_{i}^{C 2} ( {z}_{i} - {h}_{t}^{C 2} ( {x}_{i} ) )}^{2} + … + \\ {\sum }_{i = 1}^{Ntchr} {{w}_{i}^{Cm} ( {z}_{i} - {h}_{i}^{Cm} ( {x}_{i} ) )}^{2} \\ = {\sum }_{u = 1}^{m} {\sum }_{i = 1}^{Ntchr} {{w}_{i}^{Cu} ( {z}_{i} - {h}_{i}^{Cu} ( {x}_{i} ) )}^{2}\end{matrix} \qquad ( 2 )$$

Here, if the number of classes m is 3, and sharing between classes C1 and C2 is defined by the filter ft for calculating features, classification loss error is defined as follows.

$${J}_{wse} = { \underbrace{{\sum }_{i = 1}^{Ntchr} {{w}_{i}^{C 1} ( {z}_{i} - {h}_{t}^{C 1} ( {x}_{i} ) )}^{2} + {\sum }_{i = 1}^{Ntchr} {{w}_{i}^{C 2} ( {z}_{i} - {h}_{t}^{C 2} ( {x}_{i} ) )}^{2}}}_{share} + {\underbrace{{\sum }_{i = 1}^{Ntchr} {{w}_{i}^{C 3} ( {z}_{i} - {h}_{t}^{C 3} ( {x}_{i} ) )}^{2}}}_{unshare}$$

Because classes C1 and C2 share features, they may be expressed as:

hₜ^{C1}(xᵢ)=gₜ^{C1}(ft(xᵢ))

hₜ^{C2}(xᵢ)=gₜ^{C2}(ft(xᵢ)). In contrast, because features are not shared with class C3, it is necessary to select a filter separately for only class C3, which is not preferable because the amount of calculations will increase. For this reason, the present embodiment defines classification loss error J_{wse} as a constant classifying function for classes that do not share features. The method by which the constant is calculated will be described later.

Next, the learning section 40 determines weak classifiers hₜ^{Cu} such that the classification loss error J_{wse} becomes minimal (Step ST2). In the present embodiment, the classifying mechanisms are histogram type classifying functions. Therefore, weak classifiers hₜ^{Cu} are determined by generating histograms to determine scores with respect to features obtained from learning data. Note that the method by which the weak classifiers hₜ^{Cu} are determined will be described later. After the weak classifiers hₜ^{Cu} are determined in this manner, the weights wᵢ^{Cu} of the learning data xᵢ^{Cu} are updated as shown in Formula (3) below (step ST3). Note that the updated weights wᵢ^{Cu} are normalized as shown in Formula (4) below. In Formula (3), hₜ^{Cu} represents scores output by the weak classifiers with respect to the learning data xᵢ^{Cu}.

$$\begin{matrix}{w}_{i}^{Cu} = {w}_{i}^{Cu} ( old ) \cdot {e}^{- {zi}^{Cu} \cdot {ht}^{Cu}} & ( 3 ) \\ {w}_{i}^{Cu} ( new ) = \frac{{w}_{i}^{Cu}}{{\sum }_{i = 1}^{Ntchr} {w}_{i}^{Cu}} & ( 4 )\end{matrix}$$

Here, in the case that the score output by a weak classifier hₜ^{Cu} with respect to a piece of learning data is positive, the probability that the learning data is an object is the object of a classification target class is high, and if the score output by a weak classifier hₜ^{Cu} with respect to a piece of learning data is negative, the probability that the learning data is an object is the object of a classification target class is low. For this reason, if scores are positive for pieces of learning data having labels hₜ^{Cu} valued +1, the weighting wᵢ^{Cu} is updated to become smaller, and if scores are negative, the weighting wᵢ^{Cu} is updated to become greater. Meanwhile, if scores are positive for pieces of learning data having labels hₜ^{Cu} valued −1, the weighting wᵢ^{Cu} is updated to become greater, and if scores are negative, the weighting wᵢ^{Cu} is updated to become smaller. This means that if a weak classifier hₜ^{Cu} classifies a piece of positive learning data and the score output thereby is positive, the weighting of the piece of learning data is updated to become smaller, and if the score output by the weak classifier hₜ^{Cu} is negative, the weighting of the piece of learning data is updated to become greater. Likewise, if a weak classifier hₜ^{Cu} classifies a piece of negative learning data and the score output thereby is positive, the weighting of the piece of learning data is updated to become greater, and if the score output by the weak classifier hₜ^{Cu} is negative, the weighting of the piece of learning data is updated to become smaller.

Weak classifiers hₜ^{Cu} are determined and the weights wᵢ^{Cu} are updated in this manner. Thereafter, the learning section 40 combines the determined weak classifiers hₜ^{Cu} with the strong classifiers H^{Cu} for each class, to update the strong classifiers H^{Cu} (step ST4). Note that in a first process, the strong classifiers H^{Cu} are initialized to equal zero. Therefore, weak classifiers hₜ^{Cu} for the first step of the strong classifiers H^{Cu} for each class are added in the first process. Newly determined weak classifiers are added thereafter to the strong classifiers H^{Cu} for each class in a second and subsequent processes.

After the strong classifiers H^{Cu} for each class are updated in this manner, it is judged whether the percentage of correct answers of a combination the weak classifiers hₜ^{Cu} which have been determined up to that point exceeds a predetermined threshold value Th1 (step ST5). That is, the weak classifiers hₜ^{Cu} which have been determined up to that point are combined and utilized to classify positive learning data for each class. It is judged whether the percentage of results of classification that match the correct answers as to whether the pieces of learning data actually represent the object of the classification target class exceeds the threshold value Th1. In cases that the percentage of correct answers exceeds the predetermined threshold value Th1, the classification target object can be classified with a sufficiently high probability by using the weak classifiers hₜ^{Cu} which have been determined up to that point. Therefore, the classifiers are set for the classes (step ST6), and the learning process is completed. In cases that the percentage of correct answers is the threshold value Th1 or less, the process returns to step ST2, to determine additional weak classifiers hₜ^{Cu} to be linked with the weak classifiers hₜ^{Cu} which have been determined up to that point. Note that the filters ft which are employed for second and subsequent learning steps are arbitrarily selected. Therefore, there are cases in which the same filter ft is selected again before learning is completed.

The determined weak classifiers hₜ^{Cu} are linked linearly in the order that they are determined. Note that the determined weak classifiers hₜ^{Cu} may be linked in order from those having the highest percentage of correct answers, to construct the strong classifiers. In addition, score tables are generated for calculating scores according to features, based on histograms with respect to each weak classifier hₜ^{Cu}. Note that the histograms themselves may be employed as the score tables. In this case, the classification points of the histograms become the scores. The multi class classifiers are generated by performing learning of classifiers for each class in this manner.

Next, the process by which weak classifiers are determined will be described. The present embodiment utilizes histogram type classifying functions as classifying mechanisms. FIG. 9 is a diagram that illustrates an example of a histogram type classifying function. As illustrated in FIG. 9, a histogram that functions as a classifying mechanism of a weak classifier hₜ^{Cu} has the values of features as its horizontal axis, and probabilities that an object is the object of a classification target class, that is, scores, as its vertical axis. Note that scores assume values within a range from −1 to +1. In the present embodiment, weak classifiers are determined by generating histograms, more specifically, by determining scores corresponding to each feature within the histograms. Hereinafter, generation of a histogram type classifying function will be described.

In the present embodiment, weak classifiers hₜ^{Cu} are determined by generating histograms which are classifying mechanisms of the weak classifiers hₜ^{Cu}, such that the classification loss error J_{wse} becomes minimal. Here, the weak classifiers hₜ^{Cu} of each step share features. However, a description will be given for a case in which features are not shared among some classes, to describe a general process. Thereby, the classification loss error J_{wse} of Formula (2) can be modified to a sum of loss error J^{share} for classes that share features and loss error J^{unshare} for classes that do not share features, as shown in Formula (5) below. Note that because hₜ^{Cu}(xᵢ)=gₜ^{Cu}(ft (xᵢ)), the values of the horizontal axis of the histogram is substituted as ft(xᵢ)=rᵢ in Formula (5). In Formula (5), the “share” and “unshare” beneath the Σ indicate that a total sum of loss error for classes that share features and a total sum of loss error for classes that do not share features are calculated.

$$\begin{matrix}{J}_{wse} = {\sum }_{u = 1}^{m} {\sum }_{i = 1}^{Ntchr} {{w}_{i}^{Cu} ( {z}_{i}^{Cu} - {h}_{t}^{Cu} ( {x}_{i} ) )}^{2} \\ = {\sum }_{share} {\sum }_{i = 1}^{Ntchr} {{w}_{i}^{Cu} ( {z}_{i}^{Cu} - {g}_{t}^{Cu} ( {r}_{i} ) )}^{2} + \\ {\sum }_{unshare} {\sum }_{i = 1}^{Ntchr} {{w}_{i}^{Cu} ( {z}_{i}^{Cu} - {g}_{t}^{Cu} ( {r}_{i} ) )}^{2} \\ {J}^{share} + {J}^{unshare}\end{matrix} \qquad ( 5 )$$

In Formula (5), if the values of both loss error J^{share} and loss error J^{unshare} become minimal, a minimal classification loss error J_{wse} can be achieved. For this reason, assuming that the number of classes that share features is k, the loss error J^{share} of classes that share features can be represented by Formula (6) below. Note that in Formula (8), s1 through sk indicate the numerals of classes, which have been renumbered as those that share features, from among the classes of all of the classifiers. In Formula (6), if the items toward the right side of each line are represented as J_{Cs1}^{share} through J_{Cs1}^{share}, Formula (6) may be rewritten as Formula (7).

$$\begin{matrix}\begin{matrix}{J}^{share} = {\sum }_{share} {\sum }_{i = 1}^{Ntchr} {{w}_{i}^{Cu} ( {z}_{i}^{Cu} - {g}_{t}^{Cu} ( {r}_{i} ) )}^{2} \\ = {\sum }_{i = 1}^{Ntchr} {{w}_{i}^{{C}_{s 1}} ( {z}_{i}^{{C}_{s 1}} - {g}_{t}^{{C}_{s 1}} ( {r}_{i} ) )}^{2} + \\ {\sum }_{i = 1}^{Ntchr} {{w}_{i}^{{C}_{s 2}} ( {z}_{i}^{{C}_{s 2}} - {g}_{t}^{{C}_{s 2}} ( {r}_{i} ) )}^{2} \\ ⋮ \\ {+ \sum }_{i = 1}^{Ntchr} {{w}_{i}^{Csk} ( {z}_{i}^{Csk} - {g}_{t}^{Csk} ( {r}_{i} ) )}^{2}\end{matrix} & ( 6 ) \\ {J}^{share} = {J}_{Cs 1}^{share} + {J}_{Cs 2}^{share} + … + {J}_{Csk}^{share} & ( 7 )\end{matrix}$$

In Formula (7), if the values of J_{Cs1}^{share} through J_{Csk}^{share}, which are the items toward the right side of each line of Formula (7) that represent loss errors for classes that share features, become minimal, a minimal classification loss error J^{share} can be achieved. Here, because the calculation for minimizing loss errors J_{Cs1}^{share} through J_{Csk}^{share} are the same for all classes, a calculation for minimizing loss error J_{Csj}^{share} for a class Csj (j=1˜k) will be described.

Here, the values that the features can assume are limited to a predetermined range. The present embodiment segments ranges within the horizontal axis of the histogram and quantizes them into sections P1 through Pv (v=100, for example), as illustrated in FIG. 10. The segmentation is performed in order to efficiently express statistical data regarding the features of a great number of pieces of learning data, and in response to requirements with respect to memory, detection speed, and the like when implementing the classifiers. Note that the vertical axis of the histogram is determined by calculating features from all of the learning data, and then calculating statistical data using Formula (11) below. Thereby, the generated histogram reflects statistical data regarding the classification target object, and therefore classification performance is improved. In addition, the amounts of calculation required to generate histograms and during classification can be reduced. The loss error J_{Csj}^{share} a total sum of loss errors within each section P1 through Pv. Therefore, the loss error J_{Csj}^{share} can be modified as shown in Formula (8) below. Note that rᵢ∈P_{q}(q=1˜v) and the like beneath the Σ in Formula (8) indicate that the total sum of loss errors are calculated for cases that features rᵢ belong to sections P_{q}.

$$\begin{matrix}{J}_{Csj}^{share} = {\sum }_{i = 1}^{Ntchr} {{w}_{i}^{Csj} ( {z}_{i}^{Csj} - {g}_{t}^{Csj} ( {r}_{i} ) )}^{2} \\ = {\sum }_{{r}_{i} ∈ P 1} {{w}_{i}^{Csj} ( {z}_{i}^{Csj} - {g}_{t}^{Csj} ( {r}_{i} ) )}^{2} + \\ {\sum }_{{r}_{i} ∈ P 2} {{w}_{i}^{Csj} ( {z}_{i}^{Csj} - {g}_{t}^{Csj} ( {r}_{i} ) )}^{2} \\ ⋮ \\ {+ \sum }_{{r}_{i} ∈ P v} {{w}_{i}^{Csj} ( {z}_{i}^{Csj} - {g}_{t}^{Csj} ( {r}_{i} ) )}^{2}\end{matrix} \qquad ( 8 )$$

Because the histogram is quantized into sections P1 through PV as illustrated in FIG. 10, the score values gₜ^{Csj}(rᵢ)) are constant within each section. Accordingly, gₜ^{Csj}(rᵢ) can be expressed as gₜ^{Csj}(rᵢ)=θ_{eq}^{Csj}, and therefore Formula (8) can be modified into Formula (9) below.

$$\begin{matrix}{J}_{Csj}^{share} = {\sum }_{q = 1}^{v} {\sum }_{{r}_{i} ∈ Pq} {{w}_{i}^{Csj} ( {z}_{i}^{Csj} - {g}_{t}^{Csj} ( {r}_{i} ) )}^{2} \\ = {\sum }_{q = 1}^{v} {\sum }_{{r}_{i} ∈ Pq} {{w}_{i}^{Csj} ( {z}_{i}^{Csj} - {θ}_{q}^{Csj} )}^{2}\end{matrix} \qquad ( 9 )$$

Here, the values of labels zᵢ^{Csj} in Formula (9) are either +1 or −1. Accordingly, (zᵢ^{Csj}−θ_{q}^{Csj}) is either (1−θ_{q}^{Csj}) or (−1−θ_{q}^{Csj}). Accordingly, Formula (9) can be modified into Formula (10) below.

$$\begin{matrix}{J}_{Csj}^{share} = {\sum }_{q = 1}^{v} {\sum }_{{r}_{i} ∈ Pq} {{w}_{i}^{Csj} ( {z}_{i}^{Csj} - {è}_{q}^{Csj} )}^{2} \\ = {\sum }_{q = 1}^{v} \{ {( 1 - {è}_{q}^{Csj} )}^{2} \cdot {W}_{q}^{Csj +} + {( - 1 - {è}_{q}^{Csj} )}^{2} \cdot {W}_{q}^{Csj -} \}\end{matrix} \\ wherein \\ {W}_{q}^{Csj +} = {\sum }_{{r}_{i} ∈ Pq , {z}_{i}^{Csj} = 1} {w}_{i}^{Csj} , {W}_{q}^{Csj -} = {\sum }_{{r}_{i} ∈ Pq , {z}_{i}^{Csj} = - 1} {w}_{i}^{Csj} \qquad ( 10 )$$

If the value calculated by Formula (10) becomes minimal, the loss error J_{Csj}^{share} will become minimal. The value of θ_{q}^{Csj} may be determined for each section Pq such that the value calculated by Formula (10) partially differentiated by θ_{q}^{Csj} becomes 0. Accordingly, θ_{q}^{Csj} can be calculated by Formula (11) below.

$$\frac{\partial {J}_{Csj}^{share}}{\partial {è}_{q}^{Csj}} = 0 \\ ∴ - 2 ( 1 - {è}_{q}^{Csj} ) \cdot {W}_{q}^{Csj +} - 2 ( - 1 - {è}_{q}^{Csj} ) \cdot {W}_{q}^{Csj -} = 0 \\ ∴ {è}_{q}^{Csj} = \frac{{W}_{q}^{Csj +} - {W}_{q}^{Csj -}}{{W}_{q}^{Csj +} + {W}_{q}^{Csj -}} \qquad ( 11 )$$

Here, W_{q}^{Csj+} is the total sum of weights wᵢ^{Csj} with respect to pieces of learning data xᵢ having labels valued 1, that is, positive learning data xᵢ, within sections Pq of the histogram. W_{q}^{Csj-} is the total sum of weights wᵢ^{Csj} with respect to pieces of learning data xᵢ having labels valued −1, that is, negative learning data xᵢ, within sections Pq of the histogram. Because the weights wᵢ^{Csj} are known, W_{q}^{Csj+} and W_{q}^{Csj-} can be calculated, and accordingly, the vertical axis of the histogram for sections Pq, that is, the scores θ_{q}^{Csj}, can be calculated by Formula (11) above.

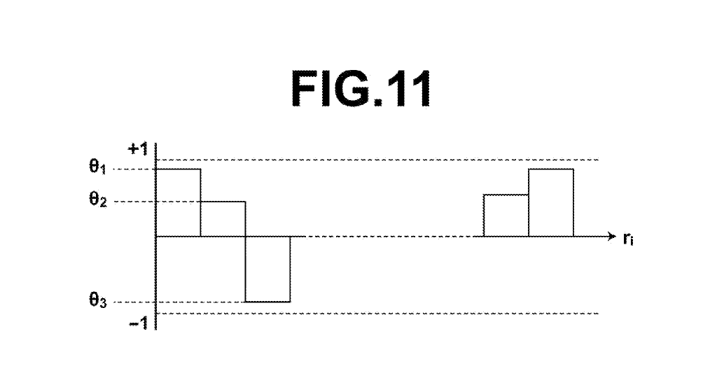

The weak classifiers hₜ^{Cu} are determined for the class Csj that shares features, by calculating the values of the vertical axis, that is, the scores θ_{q}^{Csj}, for all sections P1 through Pv of a histogram which is the classifying mechanism of the weak classifiers hₜ^{Cu} to generate a histogram such that the loss error J_{Csj}^{share} becomes minimal, by the steps described above. An example of a generated histogram is illustrated in FIG. 11. Note that in FIG. 11, the scores of sections P1, P2, and P3 are indicated as θ1, θ2, and θ3, respectively.

Next, how to minimize loss error J^{unshare} with respect to classes that do not share features will be considered. The loss error J_{Csj}^{unshare} for a class Csj which does not share features can be expressed by Formula (12) below. Here, the characteristic of the present embodiment is that features are shared. Therefore, the scores gₜ^{Cu}(rᵢ) for classes that do not share features are designated as a constant ρ^{Csj} as shown in Formula (13), and a constant ρ^{Csj} that yields the minimum loss error J_{Csj}^{unshare} is determined.

$$\begin{matrix}{J}_{Csj}^{unshare} = {\sum }_{i = 1}^{Ntchr} {{w}_{i}^{Csj} ( {z}_{i}^{Csj} - {g}_{t}^{Csj} ( {r}_{i} ) )}^{2} & ( 12 ) \\ {J}_{Csj}^{unshare} = {\sum }_{i = 1}^{Ntchr} {{w}_{i}^{Csj} ( {z}_{i}^{Csj} - {ρ}^{Csj} )}^{2} & ( 13 )\end{matrix}$$

If the value calculated by Formula (13) is minimized, the loss error J_{Csj}^{unshare} can be minimized. In order to minimize the value calculated by Formula (13), ρ^{Csj} may be set to a value such that the value calculated by Formula (13) partially differentiated by ρ^{Csj} becomes 0. Accordingly, ρ^{Csj} can be calculated by Formula (14) below.

$$\frac{\partial {J}_{Csj}^{unshare}}{\partial {\tilde{n}}^{Csj}} = 0 \\ ∴ 2 {\sum }_{i = 1}^{Ntchr} {w}_{i}^{Csj} ( {z}_{i}^{Csj} - {\tilde{n}}^{Csj} ) = 0 \\ ∴ {\tilde{n}}^{Csj} = \frac{{\sum }_{i = 1}^{Ntchr} {w}_{i}^{Csj} \cdot {z}_{i}^{Csj}}{{\sum }_{i = 1}^{Ntchr} {w}_{i}^{Csj}} \qquad ( 14 )$$

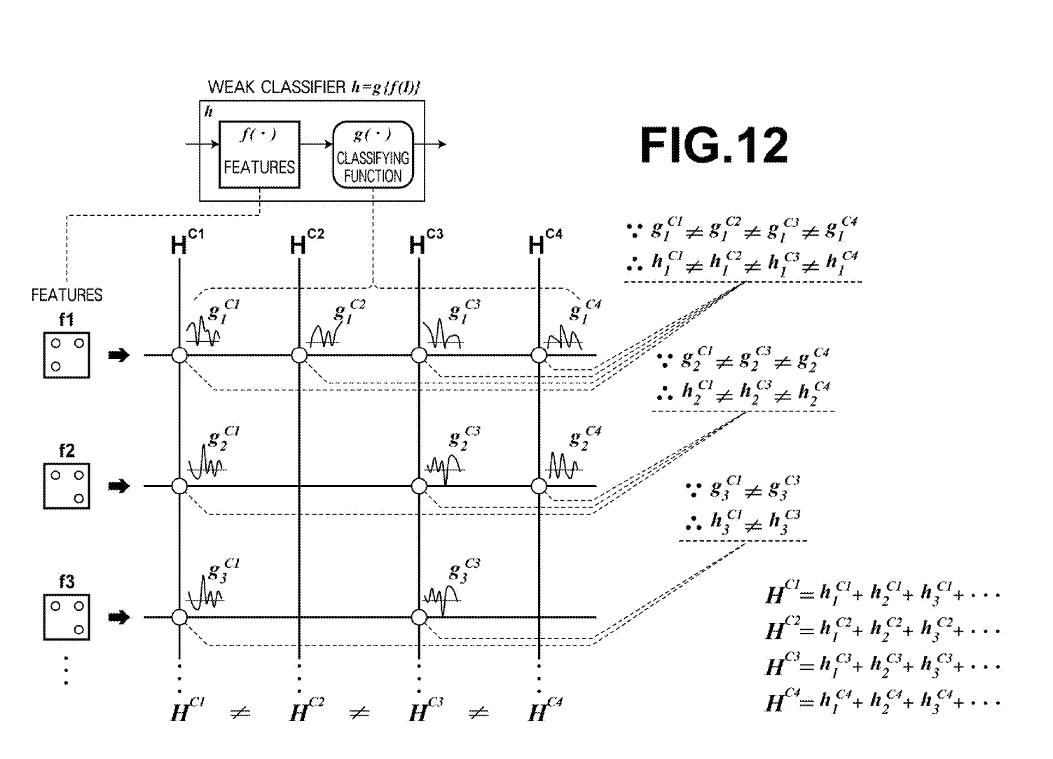

The construction of a classifier generated as described above is illustrated in FIG. 12. Note that FIG. 12 illustrates the first three steps of strong classifiers for four classes. As illustrated in FIG. 12, features f1 are shared among all classes C1 through C4 for the weak classifiers of the first step, and classifying mechanism g₁^{C1}, g₁^{C2}, g₁^{C3}, and g₁^{C4} are generated for the weak classifiers h of all of the classes C1 through C4. The pieces of learning data employed to generate the classifying mechanisms g₁^{Cj} (j=1˜4) differ (with respect to label values and weights). Therefore, the classifying functions calculated by Formula (11) also differ. Accordingly, the weak classifiers h₁^{C1} through h₁^{C4} differ among the classes. The second step of weak classifiers share features f2 among classes C1, C3, and C4, and classifying mechanisms g₂^{C1}, g₂^{C3}, and g₂^{C4} are generated for the weak classifiers h of classes C1, C3, and C4. Accordingly, weak classifiers h₁^{C1}, h₁^{C3}, and h₁^{C4}, differ among classes C1, C3, and C4. The third step of weak classifiers share features f3 between classes C1 and C3, and classifying mechanisms g₃^{C1} and g₃^{C3} are generated for the weak classifiers h of classes C1 and C3. Accordingly, weak classifiers h₁^{C1} and h₁^{C3} differ between classes C1 and C3.

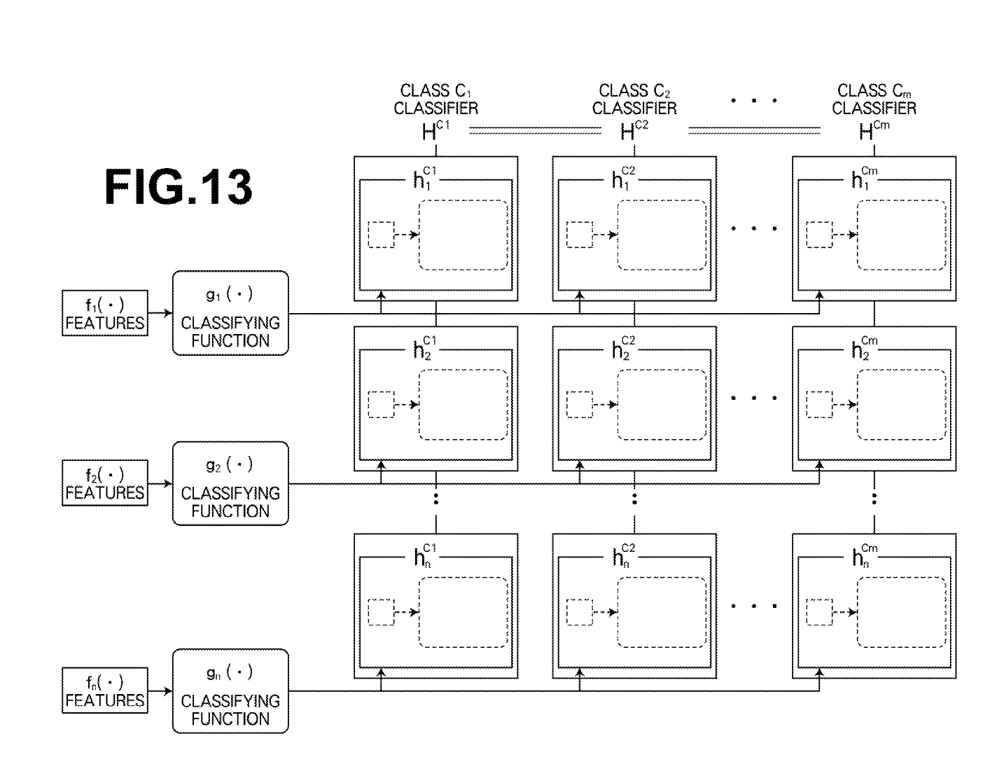

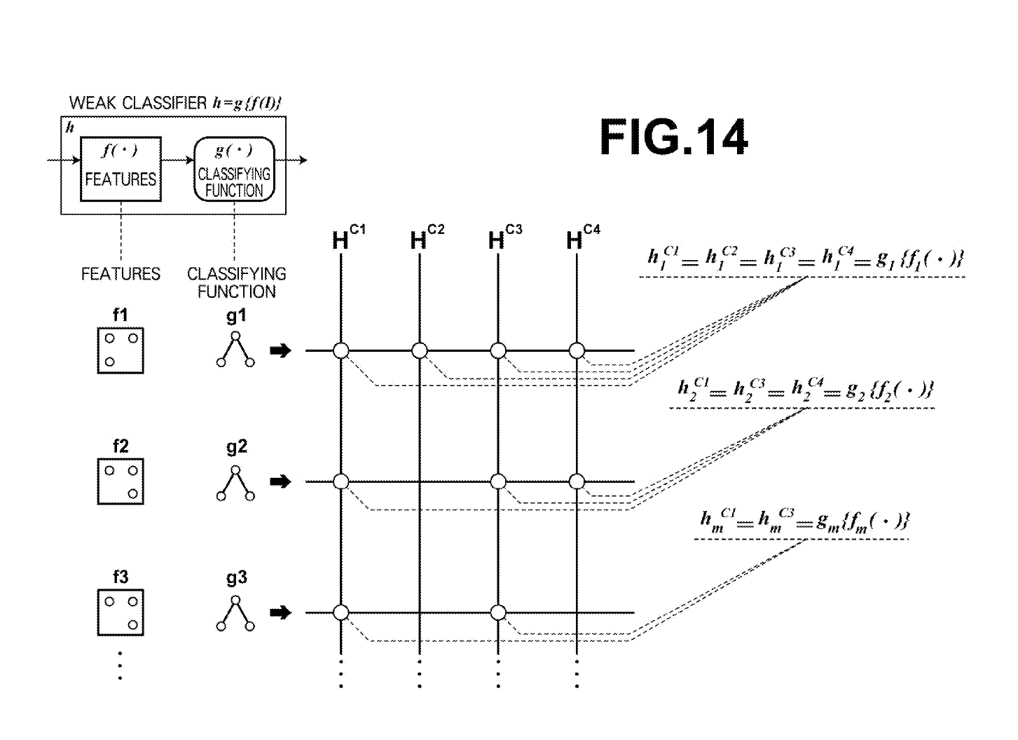

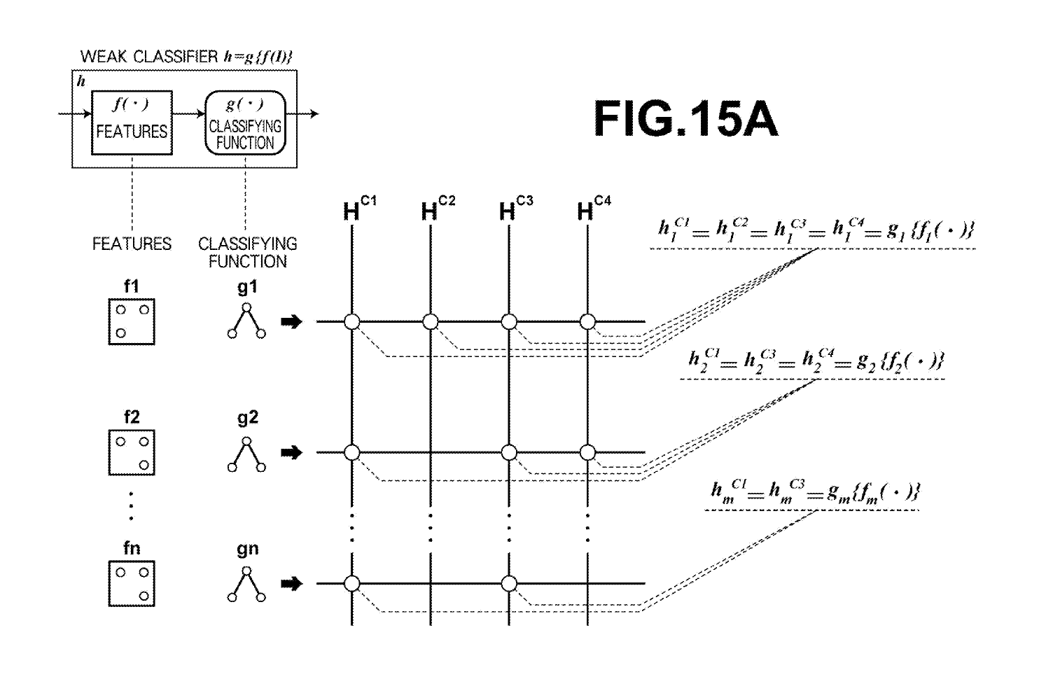

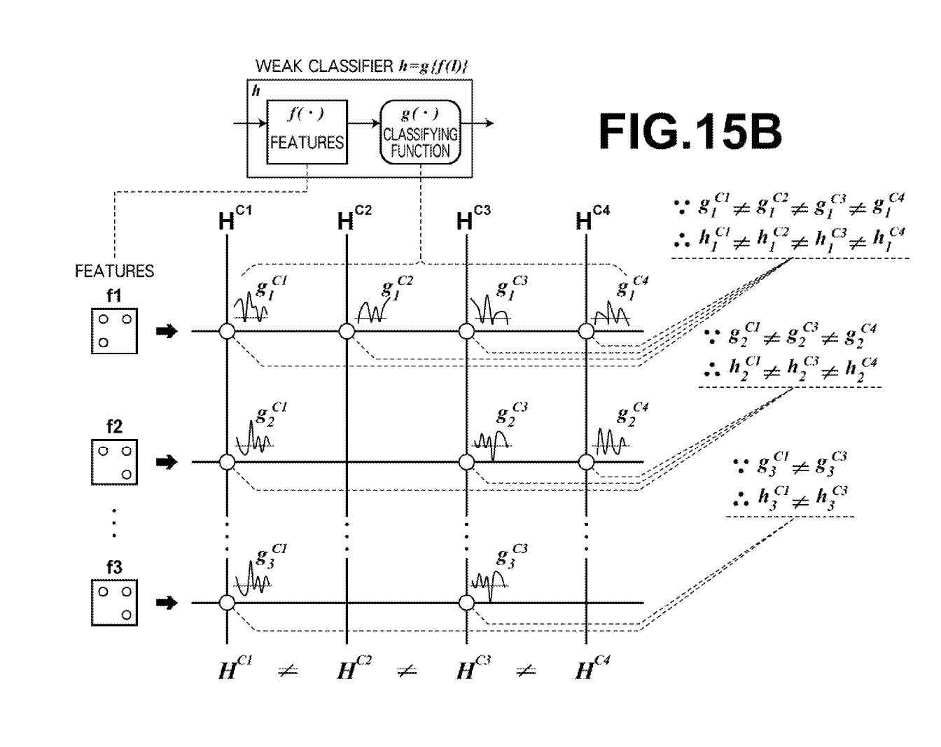

Classifiers generated by the present embodiment will be compared against classifiers generated by the Joint Boost technique. FIG. 13 is a diagram that illustrates sharing of weak classifiers in the Joint Boost technique. FIG. 14 is a diagram that illustrates the construction of a classifier generated by the Joint Boost technique. FIG. 14 illustrates the first three steps of strong classifiers for four classes in the same manner as that of FIG. 12. As illustrated in FIG. 14, features f1 are shared among all classes C1 through C4 for the weak classifiers of the first step, and a classifying mechanism g₁ is also shared for the weak classifiers h of all of the classes C1 through C4. Accordingly, the weak classifiers h₁^{C1} through h₁^{C4} for classes C1 through C4 are the same. The second step of weak classifiers share features f2 and a classifying function g₂ among classes C1, C3, and C4. Accordingly, weak classifiers h₁^{C1}, h₁^{C3}, and h₁^{C4}, are the same among classes C1, C3, and C4. The third step of weak classifiers share features f3 and a classifying function g₃ between classes C1 and C3. Accordingly, weak classifiers h₁^{C1} and h₁^{C3} are the same between classes C1 and C3. FIGS. 15A and 15B are diagrams that illustrate classifiers constructed by the Joint Boost technique and classifiers constructed by the embodiment of the present invention in a comparative manner.

As described above, the present embodiment generates classifiers, by performing learning such that only features are shared by weak classifiers of a plurality of classes, without sharing the weak classifiers. For this reason, learning not converging as in the Joint Boost technique will not occur. As a result, the converging properties of learning can be improved compared to the Joint Boost technique. In addition, because weak classifiers are not shared, classification among classes can be accurately performed. Further, because the weak classifiers of classes that share features are different from each other, designing branches of tree structures is facilitated, when classification structures, such as tree structures, are constructed. As a result, the classifier generating apparatus and the classifier generating method of the present invention are suited for designing classifiers having tree structures.

As a result of experiments conducted by the present applicant, the stability and flexibility of learning of the classifiers generated by the present invention are higher than those of classifiers generated by the Joint Boost method. In addition, it was also found that the accuracy and detected speed of classifiers generated by the present invention were higher than those of classifiers generated by the Joint Boost method.

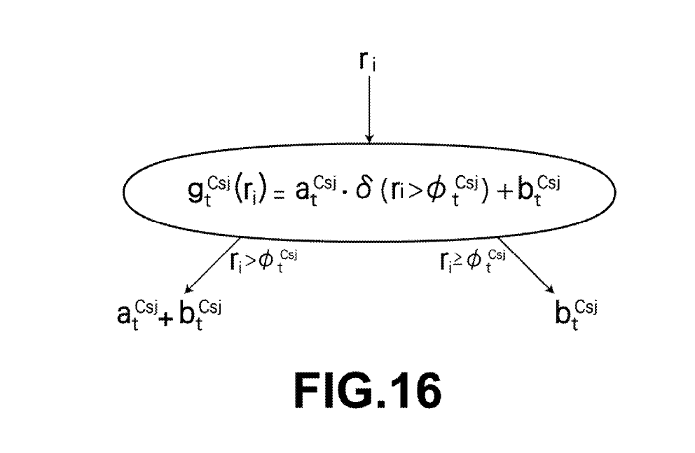

Note that the embodiment described above employs a histogram type classifying function as a classifying mechanism. Alternatively, it is possible to employ a decision tree as a classifying function. Hereinafter, determination of weak classifiers in the case that a decision tree is employed as the classifying function will be described. In the case that a decision tree is employed as the classifying function as well, the weak classifiers hₜ^{Cu} are determined such that classification loss error J_{wse} becomes minimal. For this reason, in the case that a decision tree is employed as the classifying function as well, calculations for minimizing the loss error J_{Csj}^{share} for a class Csj that shares features as shown in Formula (7) will be described. Note that in the following description, a decision tree is defined as shown in Formula (15) below. In Formula (15), Φₜ^{Csj} is a threshold value, and is defined in the filter for features. In addition, δ( ) is a delta function that assumes a value of 1 when rᵢ>Φₜ^{Csj}, and assumes a value of 0 in all other cases. Further, aₜ^{Csj} and bₜ^{Csj} are parameters. By defining a decision tree in this manner, the relationship between the input and the output of the decision tree becomes that illustrated in FIG. 16.

gₜ^{Csj}(rᵢ)=aₜ^{Csj}δ(rᵢ>φₜ^{Csj})+bₜ^{Csj} (15)

In the embodiment in which the classifying mechanism is a decision tree, the loss error J_{Csj}^{share} for a class Csj that shares features can be expressed by Formula (16) below.

$${J}_{Csj}^{share} = {\sum }_{i = 1}^{Ntchr} {{w}_{i}^{Csj} ( {z}_{i}^{Csj} - {g}_{t}^{Csj} ( {r}_{i} ) )}^{2} \qquad ( 16 )$$

If the value calculated by Formula (16) is minimized, the loss error J_{Csj}^{share} can be minimized. In order to minimize the value calculated by Formula (16), the values of aₜ^{Csj}+bₜ^{Csj} and bₜ^{Csj} may be set to a value such that the value calculated by Formula (16) partially differentiated by aₜ^{Csj} and bₜ^{Csj} respectively becomes 0. The value of aₜ^{Csj}+bₜ^{Csj} may be determined by partially differentiating the value calculated by Formula (16) by aₜ^{Csj} as shown in Formula (17) below. Note that rᵢ>φ_{q}^{Csj} beneath the Σ in Formula (17) indicates that the total sum of weights wᵢ^{Csj} when rᵢ>φ_{q}^{Csj} and products of the weights wᵢ^{Csj} and labels zᵢ^{Csj} are calculated. Accordingly, Formula (17) is equivalent to Formula (18).

$$\begin{matrix}\frac{\partial {J}_{Csj}^{share}}{\partial {a}_{t}^{Csj}} = 0 \\ \frac{\partial {J}_{Csj}^{share}}{\partial {a}_{t}^{Csj}} = 2 {\sum }_{i = 1}^{Ntchr} {w}_{i}^{Csj} ( {z}_{i}^{Csj} - {g}_{t}^{Csj} ( {r}_{i} ) \cdot \ddot{a} ( {r}_{i} > {\ddot{o}}_{t}^{Csj} ) ) = 0 \\ {\sum }_{{r}_{i} > {\ddot{o}}_{t}^{Csj}} {w}_{i}^{Csj} ( {z}_{i}^{Csj} - {a}_{t}^{Csj} - {b}_{t}^{Csj} ) = 0 \\ ∴ {a}_{t}^{Csj} + {b}_{t}^{Csj} = \frac{{\sum }_{{r}_{i} > {\ddot{o}}_{t}^{Csj}} {w}_{i}^{Csj} \cdot {z}_{i}^{Csj}}{{\sum }_{{r}_{i} > {\ddot{o}}_{t}^{Csj}} {w}_{i}^{Csj}} & ( 17 ) \\ {a}_{t}^{Csj} + {b}_{t}^{Csj} = \frac{{\sum }_{i = 1}^{Ntchr} {w}_{i}^{Csj} {z}_{i}^{Csj} \ddot{a} ( {r}_{i} > {\ddot{o}}_{t}^{Csj} )}{{\sum }_{i = 1}^{Ntchr} {w}_{i}^{Csj} \ddot{a} ( {r}_{i} > {\ddot{o}}_{t}^{Csj} )} & ( 18 )\end{matrix}$$

Meanwhile, the value of bₜ^{Csj} may be set to a value such that the value calculated by Formula (16) partially differentiated by bₜ^{Csj} becomes 0, as shown in Formula (20) below.

$$\frac{\partial {J}_{Csj}^{share}}{\partial {b}_{t}^{Csj}} = 0 \\ \frac{\partial {J}_{Csj}^{share}}{\partial {b}_{t}^{Csj}} = 2 {\sum }_{i = 1}^{Ntchr} {w}_{i}^{Csj} ( {z}_{i}^{Csj} - {g}_{t}^{Csj} ( {r}_{i} ) ) = 0 \\ {\sum }_{i = 1}^{Ntchr} {w}_{i}^{Csj} ( {z}_{i}^{Csj} - {a}_{t}^{Csj} ( {r}_{i} ) \cdot \ddot{a} ( {r}_{i} > {\ddot{o}}_{t}^{Csj} ) - {b}_{t}^{Csj} ) = 0 \\ weights {w}_{i}^{Csj} are normalized , and therefore {\sum }_{i = 1}^{Ntchr} {w}_{i}^{Csj} = 1 \\ ∴ {\sum }_{i = 1}^{Ntchr} {w}_{i}^{Csj} {z}_{i}^{Csj} - {a}_{t}^{Csj} {\sum }_{{r}_{i} {>}_{t}^{Csj}} {w}_{i}^{Csj} - {b}_{t}^{Csj} = 0 \\ ∴ {a}_{t}^{Csj} {\sum }_{{r}_{i} > {\ddot{o}}_{t}^{Csj}} {w}_{i}^{Csj} + {b}_{t}^{Csj} = {\sum }_{i = 1}^{Ntchr} {w}_{i}^{Csj} {z}_{i}^{Csj} \qquad ( 19 )$$

The value of bₜ^{Csj} can be calculated from Formula (18) and Formula (19).

$${b}_{t}^{Csj} = \frac{{\sum }_{i = 1}^{Ntchr} {w}_{i}^{Csj} {z}_{i}^{Csj} \ddot{a} ( {r}_{i} \leq {\ddot{o}}_{t}^{Csj} )}{{\sum }_{i = 1}^{Ntchr} {w}_{i}^{Csj} \ddot{a} ( {r}_{i} \leq {\ddot{o}}_{t}^{Csj} )} \qquad ( 20 )$$

Note that with respect to classes that do not share features in the case that the classifying mechanism is a decision tree, the values output by the decision tree may be designated as a constant ρ^{Csj}, and a constant ρ^{Csj} that yields the minimum loss error J_{Csj}^{unshare} may be determined in the same manner as in the case that the classifying mechanism is a histogram. In this case, the constant ρ^{Csj} may be determined in the same manner as shown in Formula (14).

As described above, in the case that the classifying mechanism is a decision tree as well, the present invention performs multi class learning sharing only the features. Therefore, learning not converging as in the Joint Boost technique will not occur. As a result, the converging properties of learning can be improved compared to the Joint Boost technique. In addition, because weak classifiers are not shared, classification among classes can be accurately performed.

An apparatus 1 according to an embodiment of the present invention has been described above. However, a program that causes a computer to function as means corresponding to the learning data input section 10, the feature pool 20, the initializing section 30, and the learning section 40 described above to perform the process illustrated in FIG. 8 is also an embodiment of the present invention. Further, a computer readable medium in which such a program is recorded is also an embodiment of the present invention.

What is claimed is:

1. A classifier generating apparatus, for generating classifiers, which are combinations of a plurality of weak classifiers, for discriminating objects included in detection target images by employing features extracted from the detection target images to perform multi class discrimination including a plurality of classes regarding the objects, comprising:
learning means, for generating the classifiers by performing learning of the weak classifiers of the plurality of classes, sharing only the features.

2. A classifier generating apparatus as defined in claim 1, further comprising:
learning data input means, for inputting a plurality of positive and negative learning data for the weak classifiers to perform learning for each of the plurality of classes; and
filter storage means, for storing a plurality of filters that extract the features from the learning data; wherein:
the learning means extracts the features from the learning data using filters selected from those stored in the filter storage means, and performs learning using the extracted features.

3. A classifier generating apparatus as defined in claim 2, wherein:
the learning means performs labeling with respect to all of the learning data to be utilized for learning according to degrees of similarity to positive learning data of classes to be learned, to stabilize learning.

4. A classifier generating apparatus as defined in claim 3, wherein the learning means performs learning by:
defining a total sum of weighted square errors of the outputs of weak classifiers at the same level in the plurality of classes with respect to the labels and input features;
defining the total sum of the total sums for the plurality of classes as classification loss error; and
determining weak classifiers such that the classification loss error becomes minimal.

5. A classifier generating apparatus as defined in claim 2, wherein:
the filters define the positions of pixels within images represented by the learning data to be employed to calculate features, the calculating method for calculating the features using the pixel values of pixels at the positions, and sharing information regarding which classes the features are to be shared among.

6. A classifier generating method, for generating classifiers, which are combinations of a plurality of weak classifiers, for discriminating objects included in detection target images by employing features extracted from the detection target images to perform multi class discrimination including a plurality of classes regarding the objects, comprising:
a learning step, for generating the classifiers by performing learning of the weak classifiers of the plurality of classes, sharing only the features.

7. A non transitory computer readable medium having a program recorded thereon that causes a computer to execute a classifier generating method, for generating classifiers, which are combinations of a plurality of weak classifiers, for discriminating objects included in detection target images by employing features extracted from the detection target images to perform multi class discrimination including a plurality of classes regarding the objects, comprising:
a learning procedure, for generating the classifiers by performing learning of the weak classifiers of the plurality of classes, sharing only the features.
